(19) United States
(12) Patent Application Publication
(10) Pub. No.: US 2020/0307592 A1
(43) Pub. Date: Oct. 1, 2020

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Takayasu Kumano, Wako-shi (JP); Suguru Yanagihara, Wako-shi (JP); Takuya Niioka, Wako-shi (JP); Yuki Motegi, Tokyo (JP)

(21) Appl. No.: 16/816,303

(22) Filed: Mar. 12, 2020

(30) Foreign Application Priority Data
Mar. 26, 2019 (JP) 2019-058100

(51) Int. Cl. B60W 30/18; B60W 10/20; B60W 10/04

(52) U.S. Cl. CPC B60W 30/18163; B60W 10/04; B60W 10/20

(57) ABSTRACT

A vehicle control device includes: the driving controller is configured to accelerate the vehicle with first acceleration in a first situation when the vehicle travels from a first lane into a second lane, accelerate the vehicle with second acceleration which is higher than the first acceleration in a second situation, the first lane being a lane in which the vehicle travels, the second lane being a lane connected to the first lane, the first situation and the second situation being a situation in the second lane at a time point before acceleration for merging and for leading to traveling in the second lane is started, the second situation being a situation in which a prospect upstream from a merging place in the second lane is worse than the first situation.

### CROSS-REFERENCE TO RELATED APPLICATION

Priority is claimed on Japanese Patent Application No. 2019-058100, filed Mar. 26, 2019, the content of which is incorporated herein by reference.

### BACKGROUND

### Field

The invention relates to a vehicle control device, a vehicle control method, and a storage medium.

### Description of Related Art

In the related art, a device that displays a mobile object pattern indicating a moving state of a mobile object which is located in a blind area of a host vehicle on a display when it is determined that a traveling position of the host vehicle is located on a pre-merging road which is connected to a road junction and it is determined that the mobile object is located in the blind area of the host vehicle is disclosed (Japanese Unexamined Patent Application, First Publication No. 2008-097279).

However, in the above-mentioned related art, control in consideration of a surrounding environment at the time of merging may not be performed.

### SUMMARY

The invention is made in consideration of the above-mentioned circumstances and an objective thereof is to provide a vehicle control device, a vehicle control method, and a storage medium that realize control of a vehicle in consideration of a surrounding environment at the time of merging.

A vehicle control device, a vehicle control method, and a storage medium according to the invention employ the following configurations.

(1) According to an aspect of the invention, a vehicle control device is provided including: a recognizer configured to recognize a surrounding environment of a vehicle; and a driving controller configured to control a steering and a speed of the vehicle on the basis of a result of recognition from the recognizer, wherein the driving controller is configured to accelerate the vehicle with first acceleration in a first situation when the vehicle travels from a first lane into a second lane, the driving controller is configured to accelerate the vehicle with second acceleration which is higher than the first acceleration in a second situation when the vehicle travels from the first lane into a second lane, the first lane being a lane in which the vehicle travels, the second lane being a lane connected to the first lane, the first situation and the second situation being a situation in the second lane at a time point before acceleration for merging and for leading to traveling in the second lane is started, the second situation being a situation in which a prospect upstream from a merging place in the second lane is worse than the first situation.

(2) In the aspect of (1), the second situation may be a situation in which a blind area is present upstream on the second lane.

(3) In the aspect of (1) or (2), the second situation may be a situation in which a curved road is present upstream on the second lane, and the driving controller may be configured to determine the second acceleration on the basis of a radius of curvature or a curvature of the curved road.

(4) In any one of the aspects of (1) to (3), the driving controller may be configured to set the second acceleration to be higher as the radius of curvature becomes less or the curvature of the curved road becomes greater.

(5) In any one of the aspects of (1) to (4), the driving controller may be configured to suppress the acceleration to a first extent in the second situation after the vehicle has traveled a predetermined distance with the second acceleration, after the vehicle has traveled a predetermined time with the second acceleration, or after the speed of the vehicle has reached a first predetermined value.

(6) In the aspect of (5), the driving controller may be configured to suppress the acceleration to a second extent which is less than the first extent in the first situation after the vehicle has traveled a predetermined distance with the first acceleration, after the vehicle has traveled a predetermined time with the first acceleration, or after the speed of the vehicle has reached a second predetermined value.

(7) In any one of the aspects of (4) to (6), the driving controller may be configured to allow the speed of the vehicle to overshoot a reference speed in comparison with a case in which control is performed in the first situation when the control is performed in the second situation.

(8) In any one of the aspects of (1) to (7), the driving controller may be configured to control the vehicle with acceleration which is higher than the first acceleration and lower than the second acceleration when the situation upstream is recognized by the recognizer before the vehicle reaches a vicinity of a position at which the first lane merges into the second lane.

(9) In the aspect of (8), the driving controller may be configured to control the vehicle such that the second acceleration increases as an extent to which the situation upstream is recognized by the recognizer becomes lower.

(10) In the aspect of (1), the driving controller is configured to determine whether a situation in the second lane at a time point before acceleration for merging and for leading to traveling in the second lane is started is the first situation or the second situation based on a result recognized by the recognizer, the driving controller is configured to accelerate the vehicle with the first acceleration when the situation is the first situation, the driving controller is configured to accelerate the vehicle with the second acceleration when the situation is the second situation.

(11) In the aspect of (1), wherein the first situation is situation in which the recognizer can recognize a situation in the second lane at a position a first distance away, the second situation is situation in which the recognizer cannot recognize a situation in the second lane at a position a first distance away.

(12) According to another aspect of the invention, a vehicle control method is provided causing a computer to perform: recognizing a surrounding environment of a vehicle; controlling a steering and a speed of the vehicle on the basis of a result of recognition; and accelerating the vehicle with first acceleration in a first situation when the vehicle travels from a first lane into a second lane, accelerating the vehicle with second acceleration which is higher than the first acceleration in a second situation when the vehicle travels from the first lane into a second lane, the first lane being a lane in which the vehicle travels, the second lane being a lane connected to the first lane, the first situation and the second situation being a situation in the second lane at a time point before acceleration for merging and for leading to traveling in the second lane is started, the second situation being a situation in which a prospect upstream from a merging place in the second lane is worse than the first situation.

(13) According to another aspect of the invention, a non-transitory computer-readable storage medium is provided that stores a computer program to be executed by a computer to perform at least: recognize a surrounding environment of a vehicle; control a steering and a speed of the vehicle on the basis of a result of recognition; and accelerate the vehicle with first acceleration in a first situation when the vehicle travels from a first lane into a second lane, accelerate the vehicle with second acceleration which is higher than the first acceleration in a second situation when the vehicle travels from the first lane into a second lane, the first lane being a lane in which the vehicle travels, the second lane being a lane connected to the first lane, the first situation and the second situation being a situation in the second lane at a time point before acceleration for merging and for leading to traveling in the second lane is started, the second situation being a situation in which a prospect upstream from a merging place in the second lane is worse than the first situation.

According to the aspects of (1) to (4), (7), (10), (11), (12) and (13), by causing the vehicle control device to control the vehicle with the second acceleration higher than the first acceleration in the second situation in which the prospect upstream from the merging place of the merging destination at the time of merging is worse than the prospect in the first situation, it is possible to realize control of a vehicle in consideration of a surrounding environment at the time of merging.

According to the aspects of (5) and (6), by suppressing the acceleration to the first extent after the vehicle has traveled a predetermined distance with the second acceleration, after the vehicle has traveled a predetermined time with the second acceleration, or after the speed of the vehicle has reached the first predetermined value, a distance from a front traffic participant can be maintained at a predetermined distance or the like even when the traffic participant or the like is located in front of the vehicle.

According to the aspects of (8) and (9), by causing the vehicle control device to control the vehicle on the basis of a result of recognition of the upstream side before the second situation starts, it is possible to further realize control of a vehicle in consideration of a surrounding environment at the time of merging.

### BRIEF DESCRIPTION OF THE DRAWINGS

FIG. 1 is a diagram illustrating a configuration of a vehicle system employing a vehicle control device according to an embodiment;

FIG. 2 is a diagram illustrating functional configurations of a first controller and a second controller;

FIG. 3 is a diagram illustrating an example of a scenario in which a first merging process is performed;

FIG. 4 is a diagram illustrating an example of a scenario in which a second merging process is performed;

FIG. 5 is a (first) diagram illustrating examples of a first pattern and a second pattern;

FIG. 6 is a (second) diagram illustrating examples of the first pattern and the second pattern;

FIG. 7 is a diagram illustrating an example of a result of control according to a comparative example;

FIG. 8 is a diagram illustrating an example of a result of control of the second merging process;

FIG. 9 is a diagram illustrating an example of a process flow which is performed by an automated driving control device;

FIG. 10 is a diagram illustrating an example of a scenario in which the second merging process is performed according to a second embodiment;

FIG. 11 is a diagram illustrating an example of a scenario in which the second merging process is performed according to the second embodiment;

FIG. 12 is a diagram illustrating an example of a relationship between a degree of recognition and acceleration;

FIG. 13 is a diagram illustrating an example of details of the second pattern of the second merging process when a degree of recognition of a blind area before arrival at a junction area is high and low;

FIG. 14 is a flowchart illustrating an example of a process flow which is performed by an automated driving control device in the second embodiment; and

FIG. 15 is a diagram illustrating an example of a hardware configuration of an automated driving control device according to an embodiment.

### DETAILED DESCRIPTION

Hereinafter, a vehicle control device, a vehicle control method, and a storage medium according to an embodiment of the invention will be described with reference to the accompanying drawings. In the following description, it is assumed that the rule of driving on the left-hand side is applied, but right and left may be exchanged with each other when the rule of driving on the right-hand side is applied.

### First Embodiment

Entire Configuration

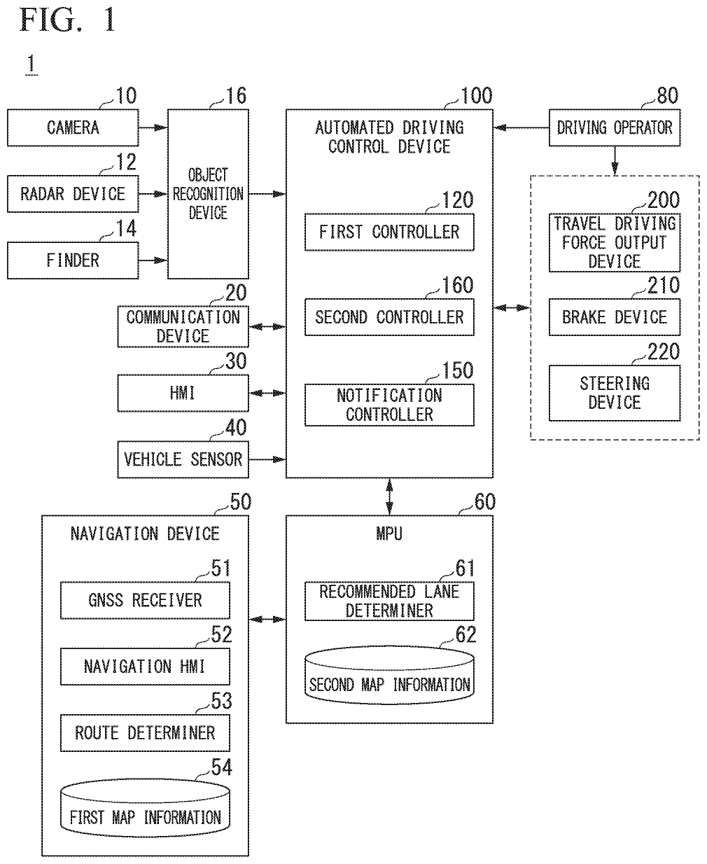

FIG. 1 is a diagram illustrating a configuration of a vehicle system 1 to which a vehicle control device according to an embodiment is applied. A vehicle in which the vehicle system 1 is mounted is, for example, a vehicle with two wheels, three wheels, or four wheels and a drive source thereof is an internal combustion engine such as a diesel engine or a gasoline engine, an electric motor, or a combination thereof. An electric motor operates using electric power which is generated by a power generator connected to the internal combustion engine or electric power which is discharged from a secondary battery or a fuel cell.

The vehicle system 1 includes, for example, a camera 10, a radar device 12, a finder 14, an object recognition device 16, a communication device 20, a human-machine interface (HMI) 30, a vehicle sensor 40, a navigation device 50, a map positioning unit (MPU) 60, a driving operator 80, an automated driving control device 100, a travel driving force output device 200, a brake device 210, and a steering device 220. These devices or instruments are connected to each other via a multiplex communication line such as a controller area network (CAN) communication line, a serial communication line, a radio communication network, or the like. The configuration illustrated in FIG. 1 is only an example and part of the configuration may be omitted or another configuration may be added thereto.

The camera 10 is, for example, a digital camera using a solid-state imaging device such as a charge coupled device (CCD) or a complementary metal oxide semiconductor (CMOS). The camera 10 is attached to an arbitrary position on a vehicle (hereinafter, referred to as a host vehicle M) in which the vehicle system 1 is mounted. For example, when the front of the vehicle M is imaged, the camera 10 is attached to an upper part of a front windshield, a rear surface of a rearview mirror, or the like. The camera 10 images surroundings of the host vehicle M, for example, periodically and repeatedly. The camera 10 may be a stereoscopic camera.

The radar device 12 radiates radio waves such as millimeter waves to the surroundings of the host vehicle M, detects radio waves (reflected waves) reflected by an object, and detects at least a position (a distance and a direction) of the object. The radar device 12 is attached to an arbitrary position on the host vehicle M. The radar device 12 may detect a position and a speed of an object using a frequency modulated continuous wave (FM-CW) method.

The finder 14 is a Light Detection and Ranging device (LIDAR). The finder 14 applies light to the surroundings of the host vehicle M and measures scattered light. The finder 14 detects a distance to an object on the basis of a time from emission of light to reception of light. The light which is applied is, for example, a pulse-like laser beam. The finder 14 is attached to an arbitrary position on the host vehicle M.

The object recognition device 16 performs a sensor fusion process on results of detection from some or all of the camera 10, the radar device 12, and the finder 14 and recognizes a position, a type, a speed, and the like of an object. The object recognition device 16 outputs the result of recognition to the automated driving control device 100. The object recognition device 16 may output the results of detection from the camera 10, the radar device 12, and the finer 14 to the automated driving control device 100 without any change. The object recognition device 16 may be omitted from the vehicle system 1.

The communication device 20 communicates with other vehicles near the host vehicle M, for example, using a cellular network, a Wi-Fi network, Bluetooth (registered trademark), or dedicated short range communication (DSRC) or communicates with various server devices via a radio base stations.

The HMI 30 presents various types of information to an occupant of the host vehicle M and receives an input operation from the occupant. The HMI 30 includes various display devices, speakers, buzzers, touch panels, switches, and keys.

The vehicle sensor 40 includes a vehicle speed sensor that detects a speed of the host vehicle M, an acceleration sensor that detects acceleration, a yaw rate sensor that detects an angular velocity around a vertical axis, and a direction sensor that detects a direction of the host vehicle M.

The navigation device 50 includes, for example, a global navigation satellite system (GNSS) receiver 51, a navigation HMI 52, and a route determiner 53. The navigation device 50 stores first map information 54 in a storage device such as a hard disk drive (HDD) or a flash memory. The GNSS receiver 51 identifies a position of the host vehicle M on the basis of signals received from GNSS satellites. The position of the host vehicle M may be identified or complemented by an inertial navigation system (INS) using the output of the vehicle sensor 40. The navigation HMI 52 includes a display device, a speaker, a touch panel, and keys. All or part of the navigation HMI 52 may be shared by the HMI 30. For example, the route determiner 53 determines a route (hereinafter, referred to as a route on a map) from the position of the host vehicle M identified by the GNSS receiver 51 (or an input arbitrary position) to a destination input by an occupant using the navigation HMI 52 with reference to the first map information 54. The first map information 54 is, for example, information in which road shapes are expressed by links indicating roads and nodes connected by the links. The first map information 54 may include a curvature of a road or point of interest (POI) information. The route on a map is output to the MPU 60. The navigation device 50 may perform guidance for a route using the navigation HMI 52 on the basis of the route on a map. The navigation device 50 may be realized, for example, by a function of a terminal device such as a smartphone or a tablet terminal which is carried by an occupant. The navigation device 50 may transmit a current position and a destination to a navigation server via the communication device 20 and may acquire a route which is equivalent to the route on a map from the navigation server.

The MPU 60 includes, for example, a recommended lane determiner 61 and stores second map information 62 in a storage device such as an HDD or a flash memory. The recommended lane determiner 61 divides the route on a map supplied from the navigation device 50 into a plurality of blocks (for example, every 100 [m] in a vehicle traveling direction) and determines a recommended lane for each block with reference to the second map information 62. The recommended lane determiner 61 determines on which lane from the leftmost the host vehicle is to travel. When there is a branching point in the route on a map, the recommended lane determiner 61 determines a recommended lane such that the host vehicle M travels on a rational route for traveling to a branching destination.

The second map information 62 is map information with higher precision than the first map information 54. The second map information 62 includes, for example, information on the center of a lane or information on boundaries of a lane. The second map information 62 may include road information, traffic regulation information, address information (addresses and postal codes), facility information, and phone number information. The second map information 62 may be updated from time to time by causing the communication device 20 to communicate with another device.

The driving operator 80 includes, for example, an accelerator pedal, a brake pedal, a shift lever, a steering wheel, a deformed steering, a joystick, and other operators. A sensor that detects an amount of operation or performing of an operation is attached to the driving operator 80, and results of detection thereof are output to some or all of the automated driving control device 100, the travel driving force output device 200, the brake device 210, and the steering device 220.

The automated driving control device 100 includes, for example, a first controller 120 and a second controller 160. The first controller 120 and the second controller 160 are realized, for example, by causing a hardware processor such as a central processing unit (CPU) to execute a program (software). Some or all of such elements may be realized in hardware (which includes circuitry) such as a large scale integration (LSI), an application specific integrated circuit (ASIC), or a field-programmable gate array (FPGA), or a graphics processing unit (GPU) or may be realized in cooperation of software and hardware. The program may be stored in a storage device such as an HDD or a flash memory of the automated driving control device 100 (a storage device including a non-transitory storage medium) in advance, or may be installed in the HDD or the flash memory of the automated driving control device 100 by storing the program in a removable storage medium (a non-transitory storage medium) such as a DVD or a CD-ROM and attaching the storage medium to the HDD or the flash memory of the automated driving control device 100.

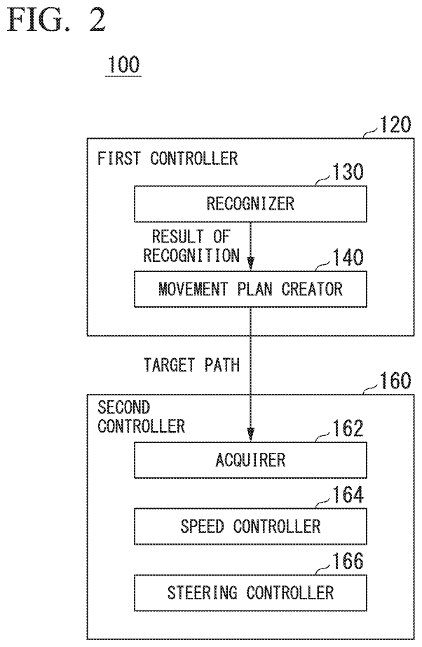

FIG. 2 is a diagram illustrating functional configurations of the first controller 120 and the second controller 160. The first controller 120 includes, for example, a recognizer 130 and a movement plan creator 140. The first controller 120 is realized, for example, by performing a function based on artificial intelligence (AI) and a function based on a predetermined model together. For example, a function of “recognizing a crossing” may be embodied by performing recognition of a crossing based on deep learning or the like and recognition based on predetermined conditions (such as signals which can be pattern-matched and road signs), scoring both recognitions, and comprehensively evaluating both recognitions. Accordingly, reliability of automated driving is secured.

The recognizer 130 recognizes states such as a position, a speed, and acceleration of an object (including a preceding vehicle, a following vehicle, and an oncoming vehicle) near the host vehicle M on the basis of information input from the camera 10, the radar device 12, and the finder 14 via the object recognition device 16. For example, a position of an object is recognized, for example, as a position in an absolute coordinate system with an origin set to a representative point of the host vehicle M (such as the center of gravity or the center of a drive shaft) and is used for control. A position of an object may be expressed as a representative point such as the center of gravity or a corner of the object or may be expressed as a drawn area. A “state” of an object may include an acceleration or a jerk of the object or a “moving state” (for example, whether lane change is being performed or whether lane change is going to be performed) thereof.

The recognizer 130 recognizes, for example, a lane (a traveling lane) on which the host vehicle M is traveling. For example, the recognizer 130 recognizes the traveling lane by comparing a pattern of road markings near the host vehicle M which are recognized from an image captured by the camera 10 with a pattern of road markings (for example, arrangement of a solid line and a dotted line) which are acquired from the second map information 62. The recognizer 130 is not limited to road markings, but may recognize the traveling lane by recognizing traveling road boundaries (road boundaries) including road markings, edges of roadsides, a curbstone, a median, and a guard rail. In this recognition, the position of the host vehicle M acquired from the navigation device 50 and the result of processing from the INS may be considered. The recognizer 130 recognizes a stop line, an obstacle, a red signal, a toll gate, or other road events.

The recognizer 130 recognizes a position or a direction of the host vehicle M with respect to a traveling lane at the time of recognition of the traveling lane. The recognizer 130 may recognize, for example, separation of a reference point of the host vehicle M from the lane center and an angle of the traveling direction of the host vehicle M with respect to a line formed by connecting the lane centers as the position and the direction of the host vehicle M relative to the traveling lane. Instead, the recognizer 130 may recognize a position of the reference point of the host vehicle M relative to one side line of the traveling lane (a road marking or a road boundary) or the like as the position of the host vehicle M relative to the traveling lane.

The recognizer 130 recognizes information on positions of nearby vehicles on the basis of nearby vehicles of the host vehicle M recognized from an image captured by the camera 10, an image captured by the camera 10, congestion information near the host vehicle M which is acquired by the navigation device 50, or position information which is acquired from the second map information 62.

The recognizer 130 may acquire various types of information received from vehicles traveling near the host vehicle M by vehicle-to-vehicle communication via the communication device 20 and recognize the surroundings of the host vehicle M on the basis of the acquired information.

The recognizer 130 recognizes whether there is a stop avoidance area in the traveling direction on the basis of at least one of an image captured by the camera 10 and position information acquired from the second map information 62. A stop avoidance area is, for example, an area in which a vehicle is not to stop such as a railroad crossing, a railroad track, a crossing, a road connected to a vehicle doorway in a place such as a fire station or an emergency hospital, a cross-walk, a safety zone, or a stop of a bus or a streetcar. The recognizer 130 may recognize a stop avoidance area, for example, on the basis of the second map information 62 or may recognize a stop avoidance area on the basis of a marker or a road sign indicating the stop avoidance area in an image captured by the camera 10.

The recognizer 130 recognizes a state of a vehicle following the host vehicle M and recognizes whether a following vehicle has stopped in a stop avoidance area. For example, the recognizer 130 recognizes whether a following vehicle has stopped in a stop avoidance area when it is recognized that the following vehicle has stopped and it is recognized that the stop avoidance area is present. When the following vehicle has a function of transmitting and receiving information on steering or acceleration/deceleration to and from nearby vehicles, the recognizer 130 may recognize that a following vehicle has stopped on the basis of the information on acceleration/deceleration or stopping of the following vehicle received via the communication device 20.

The movement plan creator 140 generates a target path in which the host vehicle M will travel autonomously (without requiring a driver's operation) in the future such that the host vehicle M travels in a recommended lane determined by the recommended lane determiner 61 in principle and copes with surrounding circumstances of the host vehicle M. A target path includes, for example, a speed element. For example, a target path is expressed by sequentially arranging points (path points) at which the host vehicle M is to arrive. Path points are points at which the host vehicle M is to arrive at intervals of a predetermined traveling distance (for example, about several [m]) along a road, and a target speed and a target acceleration at intervals of a predetermined sampling time (for example, several tenths of a [sec]) are generated as part of a target path in addition. Path points may be positions at which the host vehicle M is to arrive at sampling times every predetermined sampling time. In this case, information of a target speed or target acceleration is expressed by intervals between the path points.

The movement plan creator 140 may set events of automated driving in generating a target path. The events of automated driving include a constant-speed travel event, a low-speed following travel event, a lane change event, a branching event, a merging event, a takeover event, and an automatic parking event in which the host vehicle M travels and parks without a driver in valet parking or the like. The movement plan creator 140 generates a target path based on events which are started.

The movement plan creator 140 accelerates the host vehicle M with first acceleration in a first situation when the vehicle M travels from a first lane into a second lane, and accelerate the host vehicle M with second acceleration which is higher than the first acceleration in a second situation when the vehicle travels from the first lane into a second lane. The first lane is a lane in which the vehicle travels, the second lane is a lane connected to the first lane. The first situation and the second situation is a situation in the second lane at a time point before acceleration for merging and for leading to traveling in the second lane is started, the second situation is a situation in which a prospect upstream from a merging place in the second lane is worse than the first situation. Details of this process (a merging process) will be described later.

The second controller 160 controls the travel driving force output device 200, the brake device 210, and the steering device 220 such that the host vehicle M passes along the target paths generated by the movement plan creator 140 as scheduled.

Referring back to FIG. 2, the second controller 160 includes, for example, an acquirer 162, a speed controller 164, and a steering controller 166. The acquirer 162 acquires information of target paths (path points) generated by the movement plan creator 140 and stores the generated information in a memory (not illustrated). The speed controller 164 controls the travel driving force output device 200 or the brake device 210 on the basis of a speed element pertaining to the target path stored in the memory. The steering controller 166 controls the steering device 220 on the basis of a curved state of the target path stored in the memory. The processes of the speed controller 164 and the steering controller 166 are embodied, for example, in a combination of feed-forward control and feedback control. For example, the steering controller 166 performs feed-forward control based on a curvature of a road in front of the host vehicle M and feedback control based on separation from the target path in combination.

The travel driving force output device 200 outputs a travel driving force (a torque) for allowing a vehicle to travel to driving wheels. The travel driving force output device 200 includes, for example, a combination of an internal combustion engine, an electric motor, and a transmission and an electronic controller (ECU) that controls them. The ECU controls the above-mentioned configuration on the basis of information input from the second controller 160 or information input from the driving operator 80.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of the information input from the second controller 160 or the information input from the driving operator 80 such that a brake torque based on a braking operation is output to vehicle wheels. The brake device 210 may include a mechanism for transmitting a hydraulic pressure generated by an operation of a brake pedal included in the driving operator 80 to the cylinder via a master cylinder as a backup. The brake device 210 is not limited to the above-mentioned configuration, and may be an electronically controlled hydraulic brake device that controls an actuator on the basis of information input from the second controller 160 such that the hydraulic pressure of the master cylinder is transmitted to the cylinder.

The steering device 220 includes, for example, a steering ECU and an electric motor. The electric motor changes a direction of turning wheels, for example, by applying a force to a rack-and-pinion mechanism. The steering ECU drives the electric motor on the basis of the information input from the second controller 160 or the information input from the driving operator 80 to change the direction of the turning wheels.

First Merging Process

The movement plan creator 140 accelerates the host vehicle M with first acceleration when the host vehicle M merges from a traveling lane into a merging lane which is a merging destination and a situation of a time point before acceleration for merging and for leading to traveling in the merging lane is started is a first situation. The first situation is a situation in which a prospect upstream from the merging place of the merging lane at the time of merging is a first prospect.

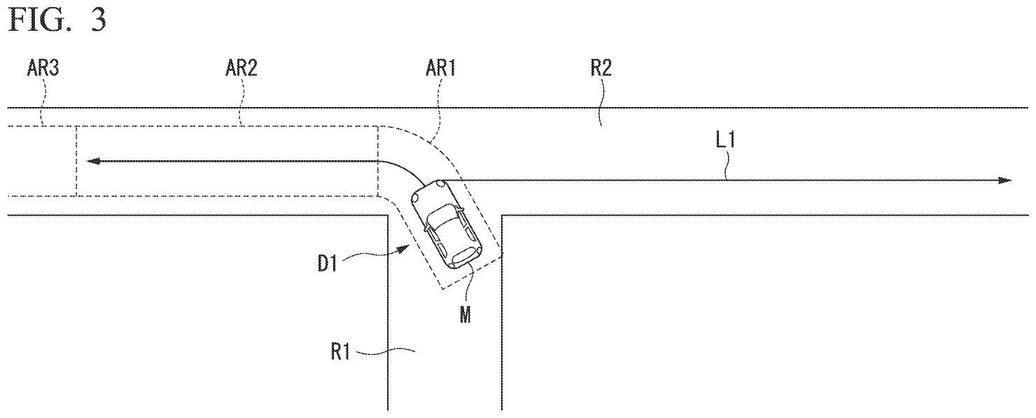

FIG. 3 is a diagram illustrating an example of a scenario in which a first merging process is performed. For example, when the host vehicle M merges from a traveling lane R1 into a merging lane R2 which is a merging destination and the host vehicle M approaches a junction area D1 (a merging place) in which the traveling lane R1 and the merging lane R2 join each other, the host vehicle M moves slowly, stops, or repeats slow movement and stopping. The host vehicle M enters the merging lane R2 from the traveling lane R1.

In this state, the movement plan creator 140 determines that the host vehicle M merges into the merging lane R2 when there is no traffic participant such as a vehicle upstream or downstream in the merging lane or when the host vehicle M can merge into the merging lane R2 safely on the basis of situations upstream and downstream in the merging lane. An upstream side is a side opposite to the traveling direction of the host vehicle M. A downstream side is a side in the traveling direction of the host vehicle M.

A “time point before acceleration for merging and for leading to traveling in the merging lane is started” is a time point at which the host vehicle M performs behavior for ascertaining the presence of a traffic participant in the merging lane (behavior such as traveling or repetition of traveling and stopping) or a time point at which the host vehicle M performs behavior for determining whether the host vehicle M is to merge into the merging lane on the basis of the surrounding environment of the host vehicle M.

A “time point before acceleration for merging and for leading to traveling in the merging lane is started” may be, for example, a time point before the movement plan creator 140 instructs the second controller 160 to accelerate in order to perform a plan of merging (after a path has been generated).

A “time point before acceleration for merging and for leading to traveling in the merging lane is started” may be a time point before a predetermined degree of a vehicle body of the host vehicle M enters an area associated with the merging lane R2, or a time point before the direction of the central axis of the vehicle body of the host vehicle M matches the extending direction of the merging lane R2. Matching may mean that the direction of the central axis of the vehicle body of the host vehicle M is included in a predetermined angle range from the extending direction of the merging lane R2.

When the prospect on the upstream side is the first prospect, it means that the recognizer 130 can recognize a situation after a first predetermined distance L1 at the “time point before acceleration for merging and for leading to traveling in the merging lane is started (for example, when the front part of the host vehicle M enters the merging lane from the traveling lane as illustrated in the drawing).” The first predetermined distance is a distance which is set according to a type of a road, a speed limit of a road, a width of a road, or the like. For example, the first predetermined distance is set to be longer as the speed of a vehicle traveling from upstream to downstream becomes higher.

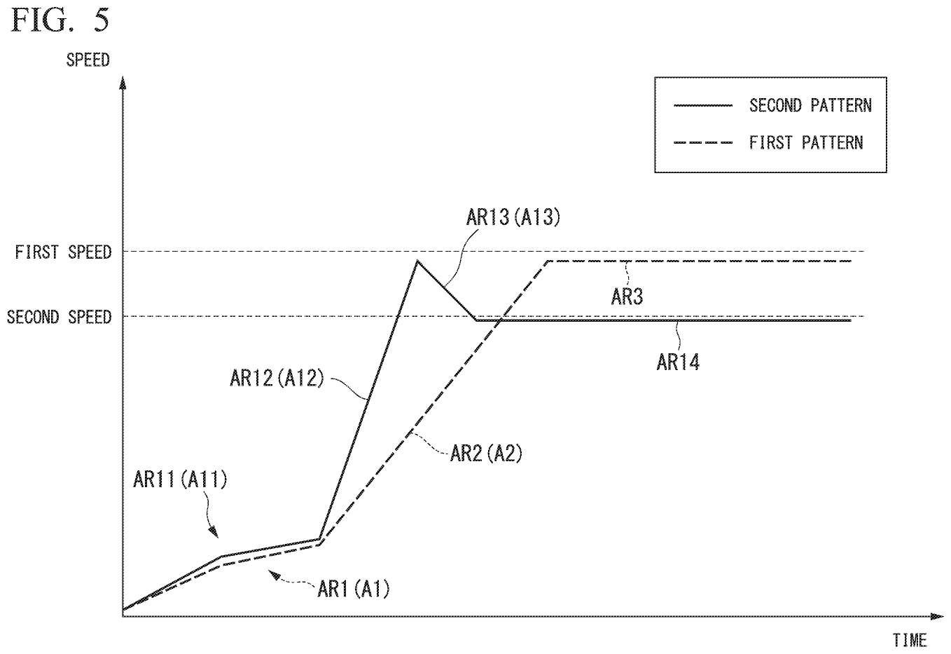

In the first situation, the host vehicle M merges from the traveling lane R1 to the merging lane R2 in a first pattern associated with acceleration and travels in the merging lane R2. For example, the host vehicle M travels with acceleration A1 in an area AR1 in the vicinity of the junction area D1, accelerates with acceleration A2 which is higher than the acceleration A1 in an area AR2 in the vicinity of the area AR1 in the merging lane, and travels in an area AR3 in the vicinity of the area AR2 in the merging lane at a speed after accelerating with the acceleration A2 (after suppressing the acceleration to a second extent). For example, the host vehicle M suppresses the acceleration to a second extent which is less than a first extent which will be described later in the area AR13 after the host vehicle M has traveled with first acceleration in the area AR2 a predetermined distance or a predetermined time, after the speed of the host vehicle M has reached a second predetermined value, or after two or more conditions out of these conditions have been satisfied. The first pattern will be described later with reference to FIG. 5.

Second Merging Process

Differences from the first merging process will be mainly described. The movement plan creator 140 accelerates the host vehicle M with second acceleration which is higher than the first acceleration when the host vehicle M merges from the traveling lane into the merging lane and the situation of a time point before acceleration for merging and for leading to traveling in the merging lane is started is a second situation. The second situation is a situation in which the prospect upstream from the merging place of the merging lane is worse than the first prospect. The second situation is a situation in which there is a blind area upstream from the merging place in the merging lane within a predetermined distance from the merging place.

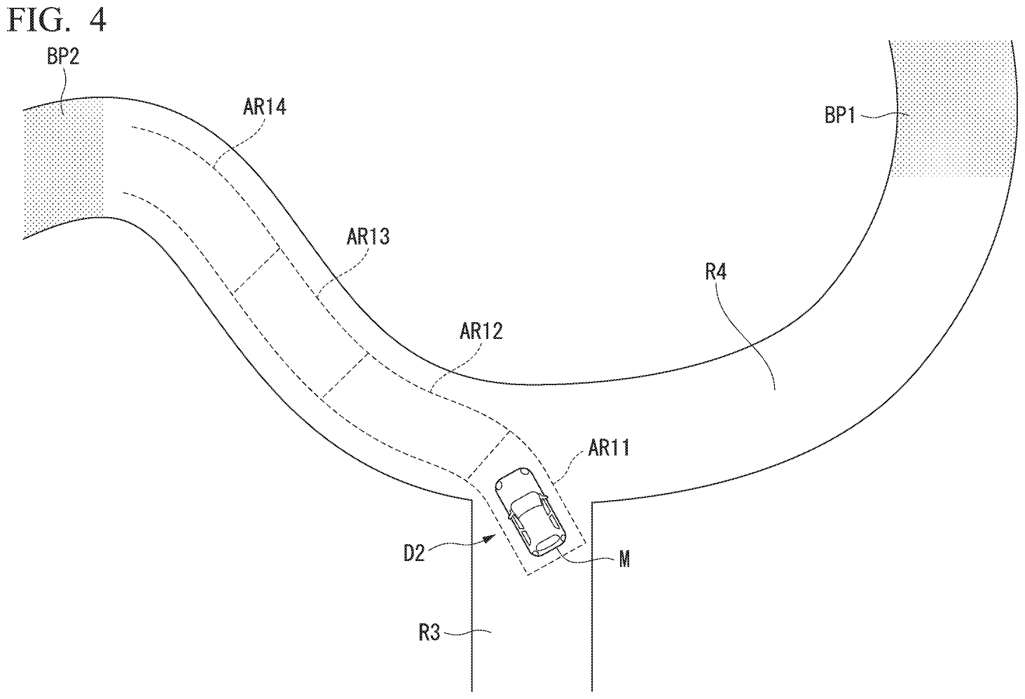

FIG. 4 is a diagram illustrating an example of a scenario in which the second merging process is performed. For example, when the host vehicle M merges from a traveling lane R3 thereof into a merging lane R4 which is a merging destination and the host vehicle M approaches a junction area D2 in which the traveling lane R3 and the merging lane R4 join each other, the host vehicle M moves slowly or stops. When predetermined conditions are satisfied, the host vehicle M enters the merging lane R4 from the traveling lane R3. The predetermined conditions include a condition that there is no traffic participant in a range which is visible from the host vehicle M or a condition that a traffic participant is present at a position a predetermined distance from the host vehicle M.

A road including the merging lane R4 in FIG. 4 is a road in which curved roads are present upstream and downstream. A situation in which the prospect upstream is a second prospect is a situation in which a blind area BP1 is present as illustrated in FIG. 4. A situation in which the prospect upstream is a second prospect is a situation in which the recognizer 130 cannot recognize a situation at a position a first predetermined distance away (a situation of the blind area BP1) and can recognize a situation at a position a second predetermined distance, which is shorter than the first predetermined distance, away. The second predetermined distance is a distance which is set according to a type of a road, a speed limit of a road, a width of a road, or the like. For example, the second predetermined distance is set to be longer as the speed of a vehicle traveling from upstream to downstream becomes higher.

In FIG. 4, a blind area BP2 is present downstream in the merging lane R4. That is, the prospect downstream is the second prospect. In other words, the recognizer 130 cannot recognize a situation at a position an eleventh predetermined distance (a situation of the blind area BP2) away downstream and can recognize a situation at a position a twelfth predetermined distance, which is shorter than the eleventh predetermined distance, away. The eleventh predetermined distance or the twelfth predetermined distance is set according to a type of a road, a speed limit of a road, a width of a road, or the like.

In the second situation, the host vehicle M merges from the traveling lane to the merging lane in a second pattern associated with acceleration and travels in the merging lane. For example, the host vehicle M travels with acceleration A11 in an area AR11 in the vicinity of the junction area D2, accelerates with acceleration A12 which is higher than the acceleration A11 in an area AR12 in the vicinity of the area AR11 in the merging lane and suppresses the acceleration with deceleration A13 (to a first extent) in an area AR13 in the vicinity of the area A12 in the merging lane. Then, the host vehicle M travels in an area AR14 in the vicinity of the area AR13 in the merging lane at a speed after suppressing the acceleration with the deceleration A13. The second pattern will be described later with reference to FIG. 5.

First Pattern and Second Pattern (First Part)

FIG. 5 is a (first) diagram illustrating an example of the first pattern and the second pattern. The vertical axis in FIG. 5 represents speed and the horizontal axis represents time. A solid transition line in FIG. 5 indicates a change in speed of the second pattern, and a dotted transition line in FIG. 5 indicates a change in speed of the first pattern. In the example illustrated in FIG. 5, a change in speed when the host vehicle M travels in the areas AR1 to AR3 using the first pattern and a change in speed when the host vehicle M travels in the areas AR11 to AR14 using the second pattern are described. In the illustrated example, an area in which the host vehicle M travels is switched at a bent point of the transition line.

For example, in the first pattern, the host vehicle M travels with acceleration A1 in the area AR1, travels with acceleration A2 (a first acceleration) in the area AR2, and travels at a first speed which is a target speed in the area AR3. For example, in the second pattern, the host vehicle M travels with acceleration A11 (acceleration equivalent to the acceleration A1) in the area AR11, travels with acceleration A12 (a second acceleration) in the area AR12, decelerates with deceleration A13 in the area AR13 before reaching the first speed (suppresses the acceleration to the first extent), and travels at a target speed (a second speed) which is lower than the first speed in the first pattern in the area AR14. For example, the host vehicle M suppresses the acceleration to the first extent after the host vehicle M has traveled with the first acceleration A12 in the area AR12 a predetermined distance or a predetermined time, after the speed of the host vehicle M has reached a first predetermined value, or after two or more conditions out of these conditions have been satisfied.

The “time point before acceleration for merging and for leading to traveling in the merging lane is started” may be a time point before a vehicle is present in the area AR11 in FIG. 5 or may be a time point at which a vehicle is present in the area AR11 in FIG. 5. The “acceleration for merging and for leading to traveling in the merging lane” is, for example, acceleration after the vehicle has entered the area AR12.

In the above-mentioned example, patterns associated with acceleration when a blind area BP2 is present downstream in the merging lane R4 have been described, but when there is no blind area, the host vehicle M travels with acceleration A12 in the area AR12 and then travels at a target speed.

The illustrated example is merely an example, and the first pattern and the second pattern may be generated such that the transition lines do not include a bent point and the transition lines are smooth. When the blind area BP2 is not present, control based on the second pattern may also be performed.

The acceleration A12 may be determined on the basis of a radius of curvature or a curvature of a curved road. For example, as the radius of curvature becomes less or as the curvature becomes greater (the curve becomes severer), the acceleration A12 may be determined to be higher acceleration.

First Pattern and Second Pattern (Second Part)

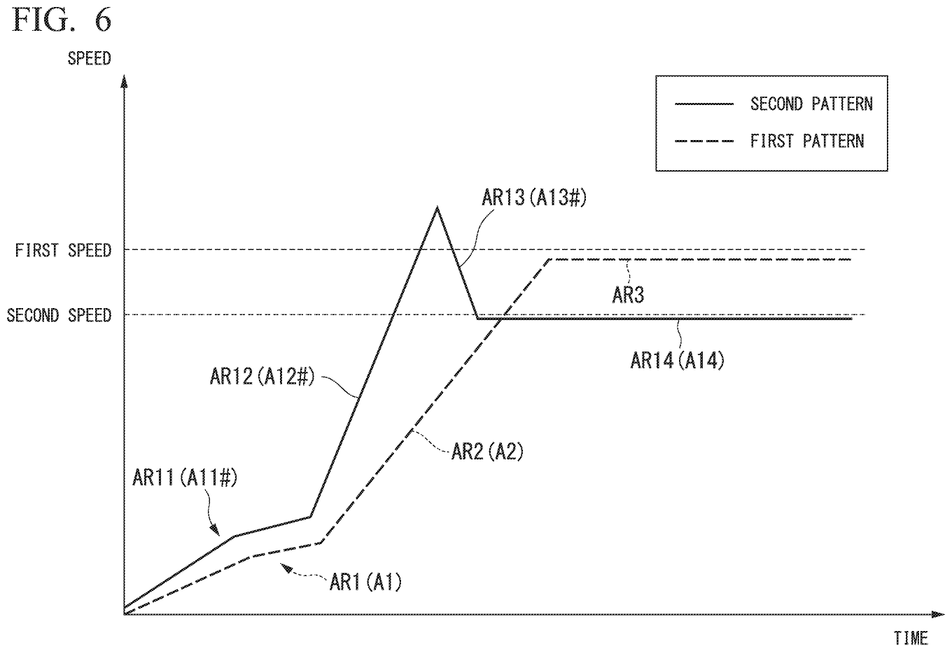

FIG. 6 is a (second) diagram illustrating an example of the first pattern and the second pattern. The same description as described with reference to FIG. 5 will not be repeated. For example, in the second pattern, the host vehicle M travels with acceleration A11# in the area AR11, travels with acceleration A12# in the area AR12, decelerates with deceleration A13# (suppresses the acceleration to a first extent) in the area AR13 after the speed has exceeded the first speed, and travels at a second speed which is lower than the first speed in the first pattern in the area AR14.

As described above, the movement plan creator 140 may set an extent to which the speed of the host vehicle M overshoots the second speed to be greater than an extent to which the speed of the host vehicle M overshoots the second speed in the first pattern.

That is, the automated driving control device 100 allows overshoot in the second merging process.

As described above, the acceleration (A11#) in the area AR11 or the acceleration (A12#) in the area AR12 may be higher than the acceleration (A11) in the area AR11 or the acceleration (A12) in the area AR12 in FIG. 5. The deceleration (A13#) in the area AR13 may be higher than the deceleration (A13) in the area AR13 in FIG. 5.

The “time point before acceleration for merging and for leading to traveling in the merging lane is started” is, for example, a time point before a vehicle is present in the area AR11 in FIG. 6. The “acceleration for merging and for leading to traveling in the merging lane” is, for example, acceleration after a vehicle has entered the area AR11.

Result of Control in Comparative Example

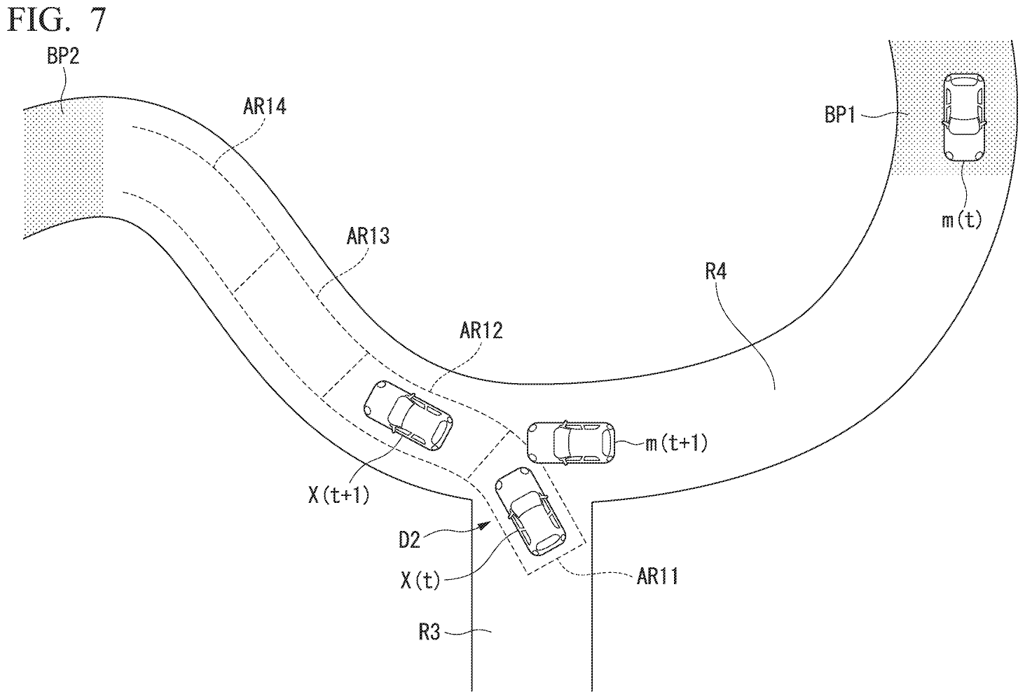

FIG. 7 is a diagram illustrating an example of a result of control in a comparative example. For example, it is assumed that a vehicle X in a comparative example merges into a merging lane R4 and travels in the merging lane R4 on the basis of the first pattern without considering a blind area BP1. In this case, the vehicle X travels with acceleration A1 in the area AR11 when it is determined that the vehicle X enters the merging lane R4 at time t, and then the vehicle X travels with acceleration A2 when it enters the area AR12. At time t+1, the vehicle X reaches the area AR12.

For example, when a vehicle m traveling in the same direction as the traveling direction of the vehicle X is present in the blind area BP1 at time t, the vehicle m may reach an area immediately after the vehicle X (the vicinity of the area AR12) at time t+1.

When the vehicle X merges into the merging lane R4 without considering presence of the blind area BP1 as described above, the distance between the following vehicle m and the vehicle X is small and thus an occupant of the vehicle X may feel discomfort. The following vehicle may perform a braking operation to a greater extent than a normal braking operation and an occupant of the following vehicle may feel more discomfort or inconvenience.

Result of Control in Second Merging Process

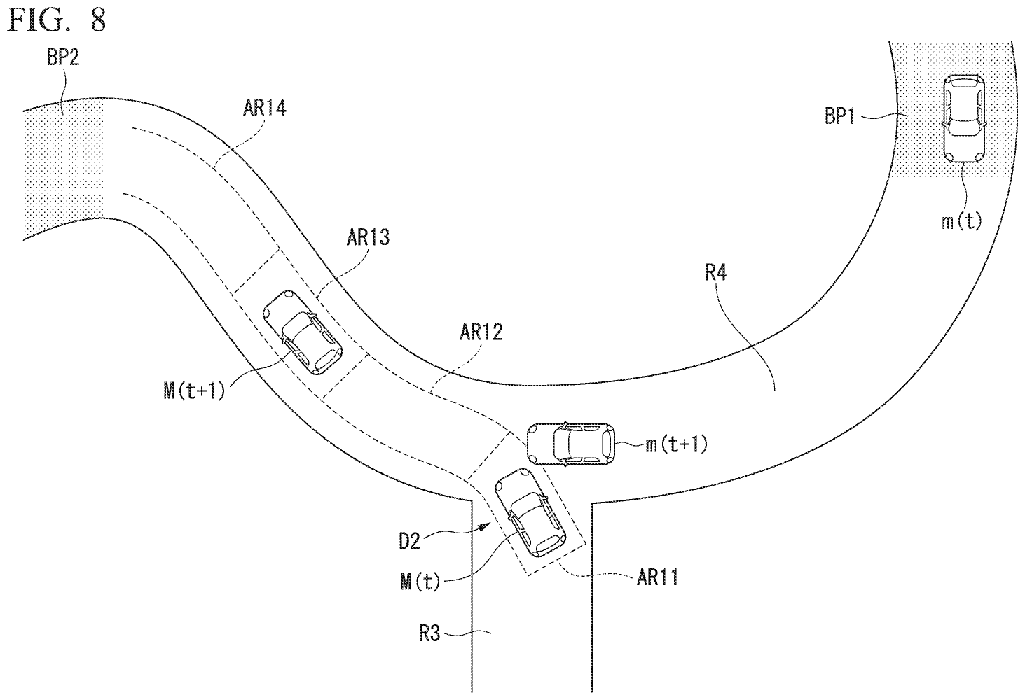

FIG. 8 is a diagram illustrating an example of a result of control in the second merging process. For example, the host vehicle M travels with acceleration A11 in the area AR11 when the host vehicle M is to enter the merging lane R4 at time t, and the host vehicle M travels with acceleration A12 when the host vehicle M enters the area AR12. At time t+1, the host vehicle M reaches the area AR13. For example, when a vehicle m traveling in the same direction as the traveling direction of the host vehicle M is present in the blind area BP1 at time t, the vehicle m is present at a position which is separated a sufficient distance from the host vehicle M at time t+1.

When the host vehicle M merges into the merging lane R4 in consideration of presence of the blind area BP1 as described above, the distance between the following vehicle and the host vehicle M is sufficiently great and an occupant of the host vehicle M is prevented from feeling discomfort. The following vehicle does not need to perform a braking operation to a greater extent than a normal braking operation and an occupant of the following vehicle is prevented from feeling more discomfort or inconvenience.

Flowchart

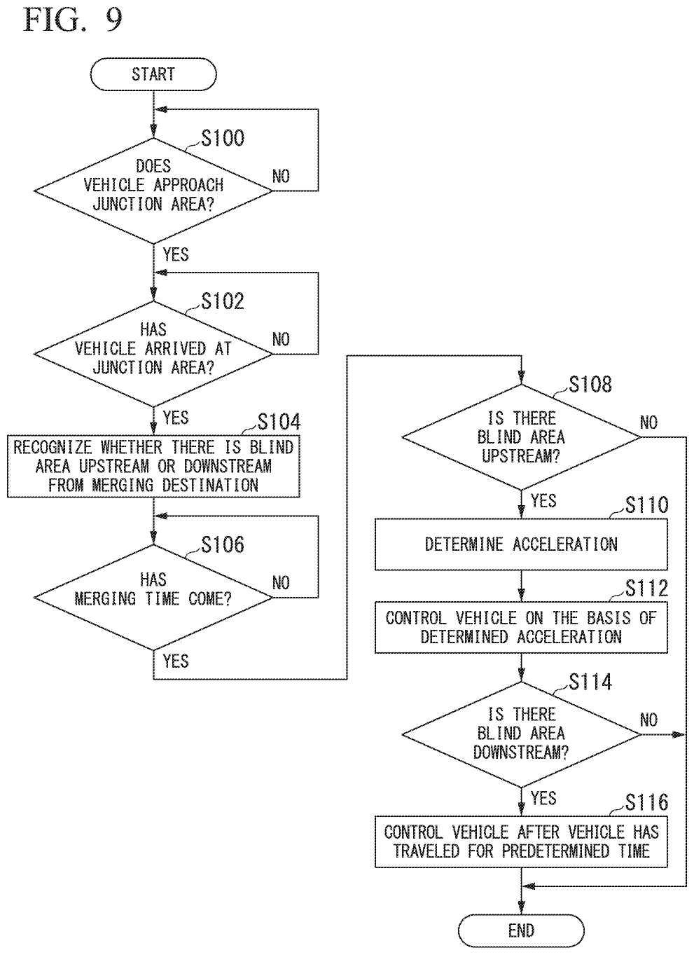

FIG. 9 is a diagram illustrating an example of a process flow which is performed by the automated driving control device 100. First, the automated driving control device 100 determines whether the host vehicle approaches a junction area (Step S100). When the host vehicle M approaches the junction area, the automated driving control device 100 determines whether the host vehicle M has arrived at the junction area (Step S102).

When the host vehicle has arrived at the junction area, the automated driving control device 100 recognizes whether there is a blind area upstream in the merging lane and whether there is a blind area downstream in the merging lane (Step s104). Then, the automated driving control device 100 determines a merging time and recognizes whether the determined merging time has come (Step S106).

When the merging time has come, the automated driving control device 100 determines whether there is a blind area upstream (Step S108). When there is no blind area upstream, the process flow of this flowchart ends.

When there is a blind area upstream in the merging lane, the automated driving control device 100 determines acceleration A12 in the merging lane (Step S110) and controls the vehicle on the basis of the determined acceleration A12 (Step S112). That is, the host vehicle M travels on the basis of the second pattern.

Then, the automated driving control device 100 determines whether there is a blind area downstream in the merging lane (Step S114). When there is no blind area downstream in the merging lane, the process flow of this flowchart ends.

When there is a blind area downstream in the merging lane, the automated driving control device 100 controls the host vehicle M such that the host vehicle travel with acceleration A12 for a predetermined time and then decelerates with deceleration A13. That is, the host vehicle M travels on the basis of the second pattern. Accordingly, the process flow of this flowchart ends.

According to the above-mentioned processes, since the host vehicle M travels on the basis of the second pattern, it is possible to realize control of a vehicle in consideration of the surrounding environment at the time of merging.

According to the first embodiment described above, since the movement plan creator 140 controls a vehicle with first acceleration when the vehicle merges from a traveling lane to a merging lane and a situation of a time point before acceleration for merging and for leading to traveling in the merging lane is started is a first situation and controls the vehicle with second acceleration which is higher than the first acceleration when the situation at the time point is a second situation, it is possible to realize control of a vehicle in consideration of the surrounding environment at the time of merging.

### Second Embodiment

A second embodiment will be described below. In the first embodiment, a blind area appears due to a shape of a road such as a curved road. In the second embodiment, it is assumed that a blind area appears due to an object (such as a building, a wall, a tree, or a vehicle) hindering visibility of a merging lane when the host vehicle M recognizes the merging lane from the traveling lane. Differences from the first embodiment will be mainly described below.

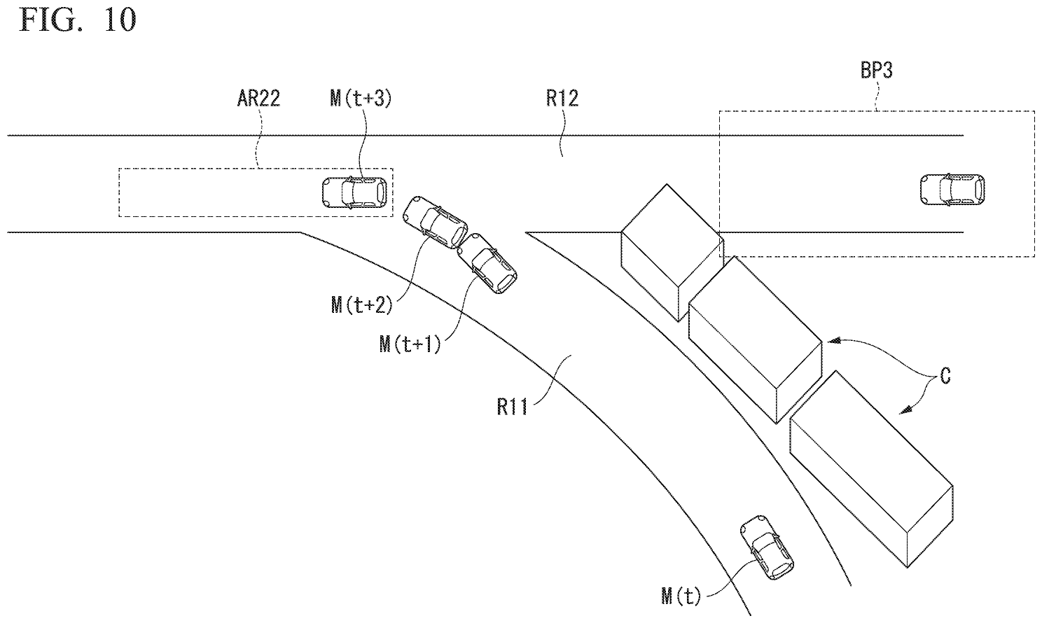

FIG. 10 is a diagram illustrating an example of a scenario in which a second merging process is performed according to the second embodiment. In the example illustrated in FIG. 10, there is a building in the vicinity of a junction area between a traveling lane R11 and a merging lane R12. When the host vehicle M merges from the traveling lane R11 to the merging lane R12, recognition of an area upstream in the merging lane R12 can be hindered by the building. That is, as illustrated in FIG. 10, a blind area BP3 is present. In this scene, the second merging process is also performed.

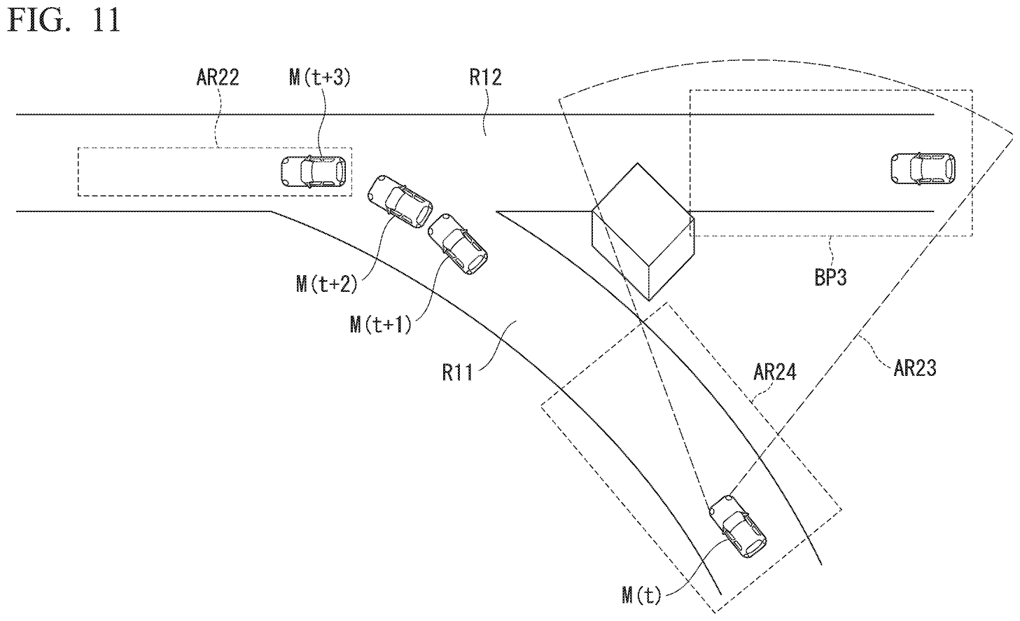

For example, the host vehicle M travels in the traveling lane R11 at time t, and the host vehicle M reaches the vicinity of a junction area t time t+1. When it is determined at time t+2 that the host vehicle M merges into the merging lane R12, the host vehicle M travels with acceleration A12 in the area AR22 at time t+3. The area AR22 is an area which is set when the direction of the central axis of the host vehicle M is substantially parallel to the extending direction of the merging lane R12 or an area which is set when the direction of the central axis of the host vehicle M is within a predetermined angle range set with respect to the extending direction of the merging lane R12. The building C in FIG. 10 will be described below with reference to FIG. 11.

As described above, even when a blind area appears due to an object, the host vehicle M can realize control of the vehicle in consideration of the surrounding environment at the time of merging. That is, the automated driving control device 100 controls the host vehicle M with acceleration which is higher than the first acceleration (acceleration A2) and lower than the second acceleration (acceleration A12) when the situation upstream in the merging lane has been recognized by the recognizer 130 before the host vehicle M has arrived at the vicinity of the position at which the traveling lane merges into the merging lane.

The acceleration in the area AR22 may be changed depending on the degree of recognition of the blind area BP3 before arriving at the vicinity of the junction area. FIG. 11 is a diagram illustrating an example of a scenario in which the second merging process is performed according to the second embodiment. In FIG. 11, the building C is not provided. For example, in a state in which the host vehicle M travels in the area AR24 of the traveling lane R11 at time t, the host vehicle M visually recognizes the area AR23 and recognizes whether there is a traffic participant such as a vehicle in the blind area BP3 or a speed or a position of the traffic participant.

At time t+1, the host vehicle M arrives at the vicinity of the junction area. At time t+2, a time at which the host vehicle M merges into the merging lane R12 is determined in consideration of the result of recognition of the blind area BP3 when the host vehicle is traveling in the area AR24. Consideration of the result of recognition refers to consideration of the time at which the traffic participant located in the blind area BP3 arrives at the vicinity of the junction area. For example, it is determined that the host vehicle M merges into the merging lane R12 at a time at which the traffic participant in the blind area BP3 has passed through the vicinity of the junction area or at a time at which the traffic participant located in the blind area BP3 appears a predetermined distance before the vicinity of the junction area.

When it is determined at time t+2 that the host vehicle M merges into the merging lane R12, the host vehicle M enters the merging lane R12. At time t+3, the host vehicle M determines the acceleration A12 in the area AR22 on the basis of the degree of recognition of the blind area BP3 when the host vehicle M is traveling in the area AR24, and travels with the determined acceleration A12. For example, as the degree of recognition of the blind area BP at the time of traveling in the area AR24 becomes higher, the acceleration becomes lower. Even when the degree of recognition is high, the acceleration A12 is determined to be higher than the acceleration A2 in the first merging process.

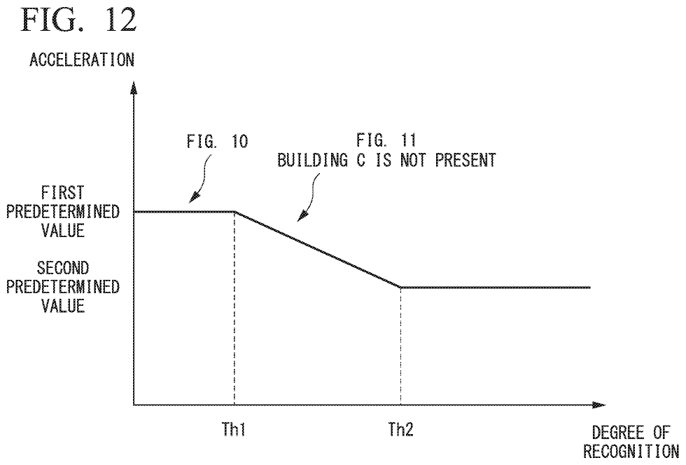

FIG. 12 is a diagram illustrating an example of a relationship between the degree of recognition and the acceleration. As the degree of recognition of a situation upstream in the merging lane by the recognizer 130 becomes lower, the second acceleration (acceleration A12) is set to become high. For example, as the degree of recognition of the blind area BP becomes higher, the acceleration is set to become lower. Specifically, for example, the acceleration is set to a first predetermined value when the degree of recognition is equal to or less than a threshold value Th1, and the acceleration changes slowly to decrease when the degree of recognition is greater than the threshold value Th1 and equal to or less than a threshold value Th2. When the degree of recognition is greater than the second threshold value Th2, the acceleration is set to a second predetermined value. The first predetermined value is greater than the second predetermined value. The threshold value Th1 is less than the threshold value Th2. The degree of recognition is acquired as a result of statistical processing of a degree of recognition of the blind area BP3 at a position of a predetermined distance before the junction area or a degree of recognition of the blind area BP3 until the host vehicle reaches the vicinity of the junction area from the position of the predetermined distance.

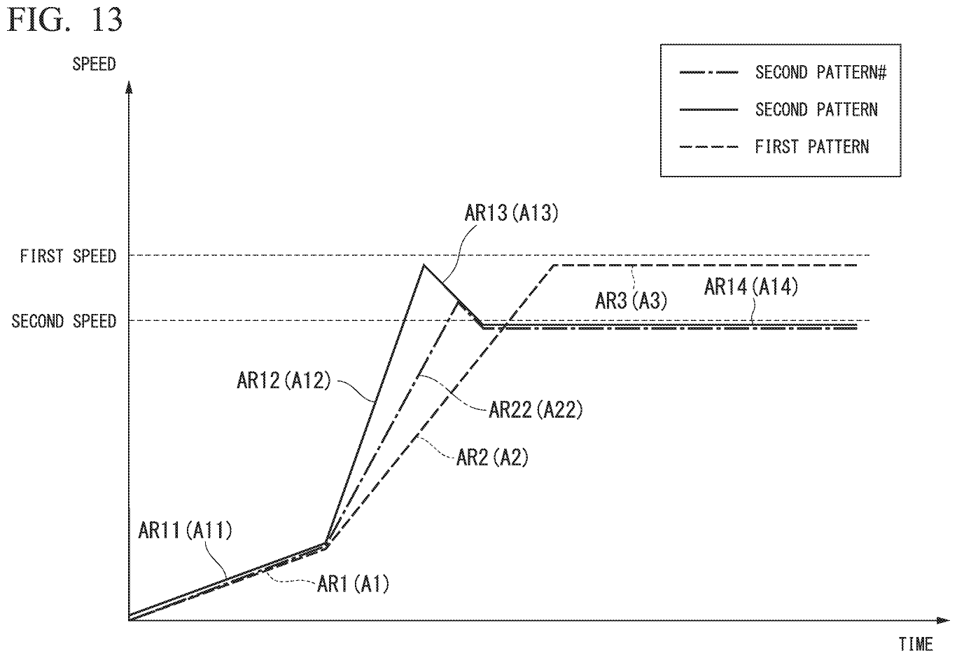

FIG. 13 is a diagram illustrating an example of details of the second pattern of the second merging process when the degree of recognition of a blind area before arrival at a junction area is high and low. For example, when the degree of recognition is low as illustrated in FIG. 10, the second pattern is employed in the second merging process. When the degree of recognition is higher than the degree of recognition in FIG. 10 as illustrated in FIG. 11, a second pattern # is employed in the second merging process. That is, the acceleration A22 when the host vehicle M travels in the area AR22 differs depending on the degree of recognition. The acceleration A22 in the area AR22 in the second pattern # is lower than the acceleration A12 in the area AR22 in the second pattern.

As described above, the automated driving control device 100 can further realize control of a vehicle in consideration of the surrounding environment at the time of merging.

Flowchart

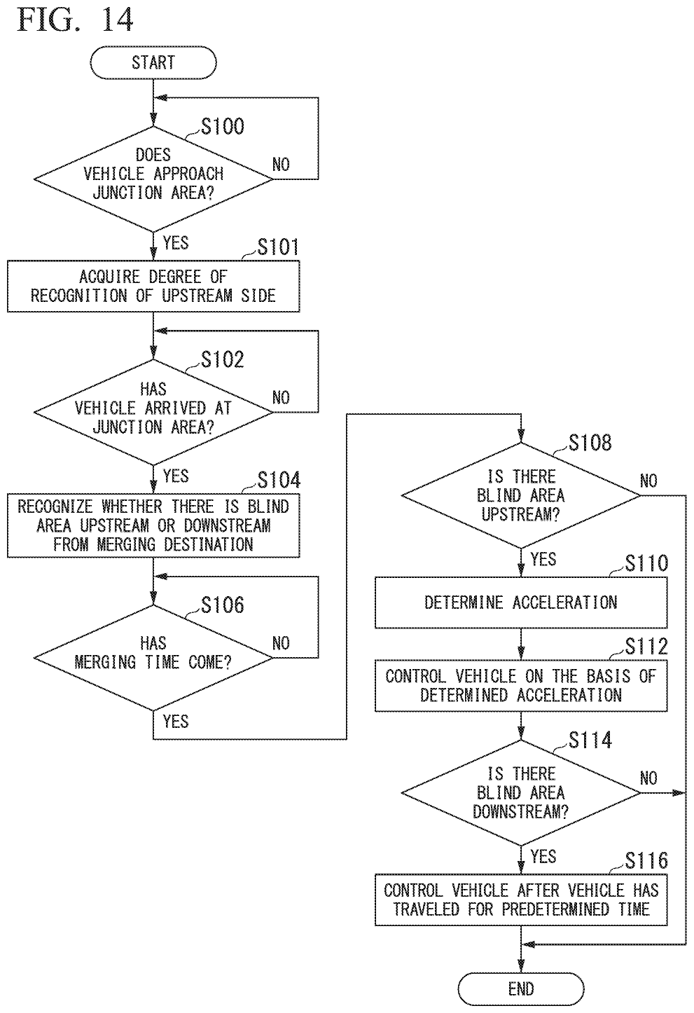

FIG. 14 is a flowchart illustrating an example of a process flow which is performed in an automated driving control device 100 according to the second embodiment. Differences from the flowchart illustrated in FIG. 10 will be described below.

When a host vehicle M approaches a junction area, the automated driving control device 100 acquires a degree of recognition of an upstream side in the merging lane R12 (Step S102). Then, after the processes of Steps S102 to S108 have been performed, the automated driving control device 100 determines acceleration in the area AR22 in consideration of the degree of recognition acquired in Step S102 (Step S110), controls the vehicle on the basis of the determined acceleration (Step S112), and performs the processes of Steps S114 and S116. In this way, the process flow in the flowchart ends.

According to the second embodiment described above, since the automated driving control device 100 controls the host vehicle with acceleration which is higher than the first acceleration and lower than the second acceleration when an upstream side of the lane which is a merging destination is recognized by the recognizer 130 before the host vehicle arrives at the merging place, it is possible to further realize control of a vehicle in consideration of the surrounding environment at the time of merging.

Hardware Configuration

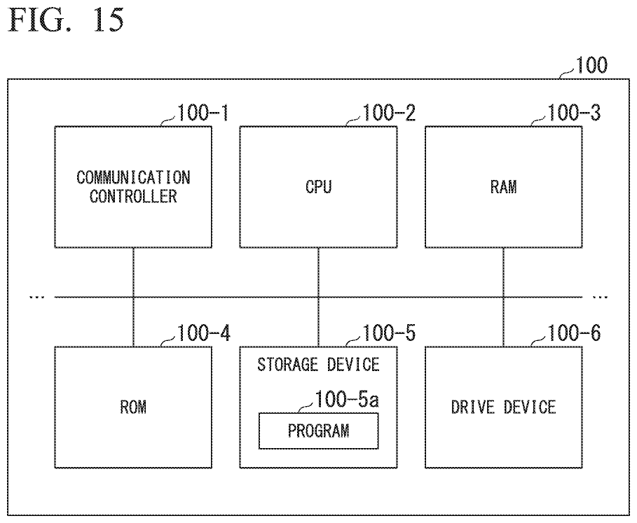

FIG. 15 is a diagram illustrating an example of a hardware configuration of the automated driving control device 100 according to the embodiment. As illustrated in the drawing, the automated driving control device 100 has a configuration in which a communication controller 100-1, a CPU 100-2, a random access memory (RAM) 100-3 which is used as a work memory, a read only memory (ROM) 100-4 that stores a booting program or the like, a storage device 100-5 such as a flash memory or a hard disk drive (HDD), a drive device 100-6, and the like are connected to each other via an internal bus or a dedicated communication line. The communication controller 100-1 communicates with elements other than the automated driving control device 100. A program 100-5a which is executed by the CPU 100-2 is stored in the storage device 100-5. This program is loaded into the RAM 100-3 by a direct memory access (DMA) controller (not illustrated) or the like and is executed by the CPU 100-2. Accordingly, some or all of the recognizer 130 and the movement plan creator 140 are embodied.

The above-mentioned embodiments can be expressed as a vehicle control device including: a storage device that stores a program; and a hardware processor, wherein the hardware processor is configured to perform, by executing the program stored in the storage device, recognizing a surrounding environment of a vehicle, recognizing a surrounding environment of a vehicle; controlling a steering and a speed of the vehicle on the basis of a result of recognition; and accelerating the vehicle with first acceleration in a first situation when the vehicle travels from a first lane into a second lane, accelerating the vehicle with second acceleration which is higher than the first acceleration in a second situation when the vehicle travels from the first lane into a second lane, the first lane being a lane in which the vehicle travels, the second lane being a lane connected to the first lane, the first situation and the second situation being a situation at a time point before acceleration for merging and for leading to traveling in the second lane is started, the second situation being a situation in which a prospect upstream from a merging place in the second lane is worse than the first situation.

While the invention has been described with reference to an embodiment, the invention is not limited to the embodiment and can be subjected to various modifications and substitutions without departing from the gist of the invention.

What is claimed is:

1. A vehicle control device comprising:
a recognizer configured to recognize a surrounding environment of a vehicle; and
a driving controller configured to control a steering and a speed of the vehicle on the basis of a result of recognition from the recognizer,
wherein the driving controller is configured to accelerate the vehicle with first acceleration in a first situation when the vehicle travels from a first lane into a second lane, the driving controller is configured to accelerate the vehicle with second acceleration which is higher than the first acceleration in a second situation when the vehicle travels from the first lane into a second lane,
the first lane being a lane in which the vehicle travels,
the second lane being a lane connected to the first lane,
the first situation and the second situation being a situation in the second lane at a time point before acceleration for merging and for leading to traveling in the second lane is started,
the second situation being a situation in which a prospect upstream from a merging place in the second lane is worse than the first situation.

2. The vehicle control device according to claim 1, wherein the second situation is a situation in which a blind area is present upstream in the second lane.

3. The vehicle control device according to claim 1, wherein the second situation is a situation in which a curved road is present upstream in the second lane, and
wherein the driving controller is configured to determine the second acceleration on the basis of a radius of curvature or a curvature of the curved road.

4. The vehicle control device according to claim 3, wherein the driving controller is configured to set the second acceleration to be higher as the radius of curvature becomes less or the curvature of the curved road becomes greater.

5. The vehicle control device according to claim 1, wherein the driving controller is configured to suppress the acceleration to a first extent in the second situation after the vehicle has traveled a predetermined distance with the second acceleration, after the vehicle has traveled a predetermined time with the second acceleration, or after the speed of the vehicle has reached a first predetermined value.

6. The vehicle control device according to claim 5, wherein the driving controller is configured to suppress the acceleration to a second extent which is less than the first extent in the first situation after the vehicle has traveled a predetermined distance with the first acceleration, after the vehicle has traveled a predetermined time with the first acceleration, or after the speed of the vehicle has reached a second predetermined value.

7. The vehicle control device according to claim 4, wherein the driving controller is configured to allow the speed of the vehicle to overshoot a reference speed in comparison with a case in which control is performed in the first situation when the control is performed in the second situation.

8. The vehicle control device according to claim 1, wherein the driving controller is configured to control the vehicle with acceleration which is higher than the first acceleration and lower than the second acceleration when the situation upstream is recognized by the recognizer before the vehicle reaches a vicinity of a position at which the first lane merges into the second lane.

9. The vehicle control device according to claim 8, wherein the driving controller is configured to control the vehicle such that the second acceleration increases as an extent to which the situation upstream is recognized by the recognizer becomes lower.

10. The vehicle control device according to claim 1,
wherein the driving controller is configured to determine whether a situation in the second lane at a time point before acceleration for merging and for leading to traveling in the second lane is started is the first situation or the second situation based on a result recognized by the recognizer ,
the driving controller is configured to accelerate the vehicle with the first acceleration when the situation is the first situation,
the driving controller is configured to accelerate the vehicle with the second acceleration when the situation is the second situation.

11. The vehicle control device according to claim 1,
wherein the first situation is situation in which the recognizer can recognize a situation in the second lane at a position a first distance away, the second situation is situation in which the recognizer cannot recognize a situation in the second lane at a position a first distance away.

12. A vehicle control method of causing a computer to perform:
recognizing a surrounding environment of a vehicle;
controlling a steering and a speed of the vehicle on the basis of a result of recognition; and
accelerating the vehicle with first acceleration in a first situation when the vehicle travels from a first lane into a second lane,
accelerating the vehicle with second acceleration which is higher than the first acceleration in a second situation when the vehicle travels from the first lane into a second lane,
the first lane being a lane in which the vehicle travels,
the second lane being a lane connected to the first lane,
the first situation and the second situation being a situation in the second lane at a time point before acceleration for merging and for leading to traveling in the second lane is started,
the second situation being a situation in which a prospect upstream from a merging place in the second lane is worse than the first situation.

13. A non-transitory computer-readable storage medium that stores a computer program to be executed by a computer to perform at least:
recognize a surrounding environment of a vehicle;
control a steering and a speed of the vehicle on the basis of a result of recognition; and
accelerate the vehicle with first acceleration in a first situation when the vehicle travels from a first lane into a second lane,
accelerate the vehicle with second acceleration which is higher than the first acceleration in a second situation when the vehicle travels from the first lane into a second lane,
the first lane being a lane in which the vehicle travels,
the second lane being a lane connected to the first lane,
the first situation and the second situation being a situation in the second lane at a time point before acceleration for merging and for leading to traveling in the second lane is started,
the second situation being a situation in which a prospect upstream from a merging place in the second lane is worse than the first situation.
